(19) United States
(12) Patent Application Publication
(10) Pub. No.: US 2025/0280275 A1
(43) Pub. Date: Sep. 4, 2025

(54) COMMUNICATION DEVICE AND COMMUNICATION SYSTEM

(71) Applicant: SONY SEMICONDUCTOR SOLUTIONS CORPORATION, KANAGAWA (JP)

(72) Inventor: SHU SAIKAWA, KANAGAWA (JP)

(21) Appl. No.: 18/862,836

(22) PCT Filed: Apr. 17, 2023
(86) PCT No.: PCT/JP2023/015367

§ 371 Date: Nov. 4, 2024

(30) Foreign Application Priority Data
May 10, 2022 (JP) 2022-077783

(51) Int. Cl. H04W 4/80

(52) U.S. Cl. CPC H04W 4/80

(57) ABSTRACT

A communication device according to one embodiment of the present disclosure includes: a detector configured to detect a signal input that comes from outside; and a changer configured to use a fact that there is a detection in the detector as a trigger to change a Connection Interval for Bluetooth (registered trademark) Low Energy.

### TECHNICAL FIELD

The present disclosure relates to a communication device and a communication system.

### BACKGROUND ART

As a communication standard for performing wireless communication with extremely low consumption of electric power, Bluetooth (registered trademark) Low Energy (hereinafter referred to as BLE) is known. For example, Patent Literature 1 describes wireless communication by using BLE.

### CITATION LIST

### Patent Literature

Patent Literature 1: Japanese Unexamined Patent Application Publication No. 2021-61460

### SUMMARY OF THE INVENTION

Incidentally, there is an issue that wireless communication by using BLE, due to its lower responsiveness, is not suitable for applications where higher responsiveness is demanded. Therefore, it is desirable to provide a communication device and a communication system that make it possible to acquire responsiveness in accordance with an application.

A communication device according to one embodiment of the present disclosure includes: a detector configured to detect a signal input that comes from outside; and a changer configured to use a fact that there is a detection in the detector as a trigger to change a Connection Interval for Bluetooth (registered trademark) Low Energy.

A communication system according to one embodiment of the present disclosure includes a master device and a slave device communicable to each other by using a Bluetooth (registered trademark) Low Energy communication. The master device includes: a detector configured to detect a signal input that comes from outside; and a communicator configured to use a fact that there is a detection in the detector as a trigger to transmit, to the slave device by using a BLE communication, a change instruction for a value of a Connection Interval for BLE.

### BRIEF DESCRIPTION OF THE DRAWINGS

FIG. 1 is a diagram illustrating an example of an outline configuration of a communication system according to a first embodiment of the present disclosure.

FIG. 2 is a diagram illustrating an example of functional blocks of a terminal device illustrated in FIG. 1.

FIG. 3 is a diagram illustrating an example of functional blocks of a left-side earphone illustrated in FIG. 1.

FIG. 4 is a diagram illustrating an example of functional blocks of a right-side earphone illustrated in FIG. 1.

FIG. 5 is a diagram illustrating an example of a communication procedure for the left-side earphone and the right-side earphone in the communication system illustrated in FIG. 1.

FIG. 6 is a diagram illustrating an example of a communication procedure for the left-side earphone and the right-side earphone in the communication system illustrated in FIG. 1.

FIG. 7 is a diagram illustrating an example of a communication procedure for the left-side earphone and the right-side earphone in the communication system illustrated in FIG. 1.

FIG. 8 is a diagram illustrating an example of a communication procedure for the left-side earphone and the terminal device in the communication system illustrated in FIG. 1.

FIG. 9 is a diagram illustrating an example of an outline configuration of a communication system according to a second embodiment of the present disclosure.

FIG. 10 is a diagram illustrating an example of functional blocks of a smart speaker illustrated in FIG. 9.

FIG. 11 is a diagram illustrating an example of a communication procedure for the smart speaker and the terminal device in the communication system illustrated in FIG. 9.

### MODES FOR CARRYING OUT THE INVENTION

Hereinafter, embodiments for practicing the present disclosure are described in detail with reference to the drawings.

### 1. Background of BLE

When a central device performs coupling with respect to a peripheral device in a state where the peripheral device is outputting a beacon (advertise), the central serves as a master, and the peripheral serves as a slave. At this time, there is a transition in communication face from an advertise channel to a data channel. As there is a transition in communication face to the data channel, the master outputs data packets at constant intervals to the slave at a master's timing. The timing is called a Connection Event. The interval at which data packets are to be outputted is called a Connection Interval. It is possible to set a value of the Connection Interval within a range between 7.5 ms to 4 sec. The Connection Interval is shared between the master and the slave.

In a case where a Connection Interval is shorter, responsiveness and a communication speed increase, but consumption of electric power also increases. In a case where a Connection Interval is longer, responsiveness and a communication speed decrease, but consumption of electric power is suppressed to low. Therefore, it is difficult to use a communication device, in a case where such a value that extends a Connection Interval longer is set, for an application where higher responsiveness is demanded. Then, the inventors of the present application propose a communication device and a communication system including the communication device that make it possible to acquire responsiveness in accordance with an application, which are described below.

### 2. First Embodiment

### [Configuration]

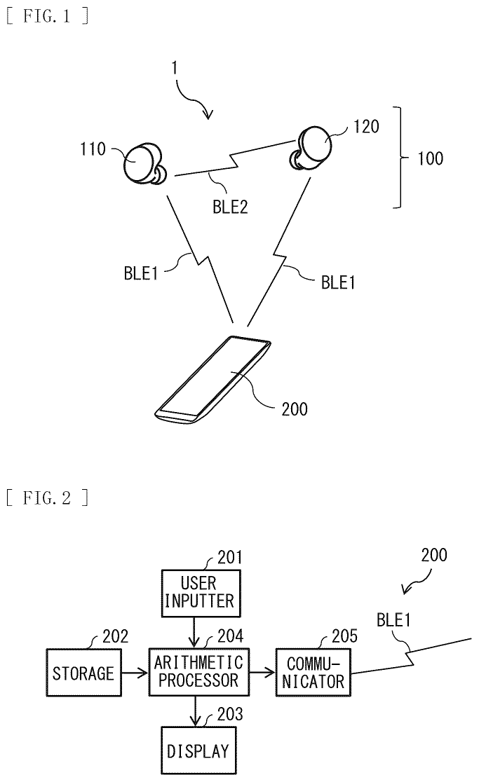

A communication system 1 according to a first embodiment of the present disclosure will now be described herein. FIG. 1 illustrates an outline configuration example of the communication system 1. The communication system 1 includes, for example, as illustrated in FIG. 1, a wireless earphone device 100 and a terminal device 200. The wireless earphone device 100 includes, for example, as illustrated in FIG. 1, a left-side earphone 110 and a right-side earphone 120. The left-side earphone 110 corresponds to one specific example of a “master device” according to the present disclosure. The right-side earphone 120 corresponds to one specific example of a “slave device” according to the present disclosure.

The left-side earphone 110, the right-side earphone 120, and the terminal device 200 are communicable to each other by using a BLE standard that is one of extended specifications relating to Bluetooth (registered trademark) that is one of wireless communication standards stipulated by a special interest group (SIG). In FIG. 1, a communication network based on BLE, which is formed between the left-side earphone 110 and the right-side earphone 120 and the terminal device 200, is expressed as BLE1, and a communication network based on BLE, which is formed between the left-side earphone 110 and the right-side earphone 120, is expressed as BLE2.

The terminal device 200 is configured to transmit data including music data, for example, with respect to the wireless earphone device 100 via the communication network BLE1. The terminal device 200 includes, for example, as illustrated in FIG. 2, a user inputter 201, a storage 202, a display 203, an arithmetic processor 204, and a communicator 205.

The user inputter 201 includes, for example, an input interface including a touch panel. The storage 202 includes, for example, a volatile memory such as a dynamic random-access memory (DRAM) or a non-volatile memory such as an electrically erasable programmable read-only memory (EEPROM) or a flash memory. The storage 202 stores, for example, a program describing a series of processing for operating the wireless earphone device 100 in a remote manner. The arithmetic processor 204 is configured to execute the program read from the storage 202, for example, to execute the series of processing for operating the wireless earphone device 100 in a remote manner. The display 203 is configured to display, for example, content for supporting an input to be performed into the user inputter 201. The communicator 205 includes an interface configured to perform communication with the wireless earphone device 100 via the communication network BLE1. The communicator 205 is configured to transmit data including music data, for example, with respect to the wireless earphone device 100 via the communication network BLE1. The communicator 205 is configured to receive data including a command, for example, from the wireless earphone device 100 via the communication network BLE1.

### (Left-Side Earphone 110)

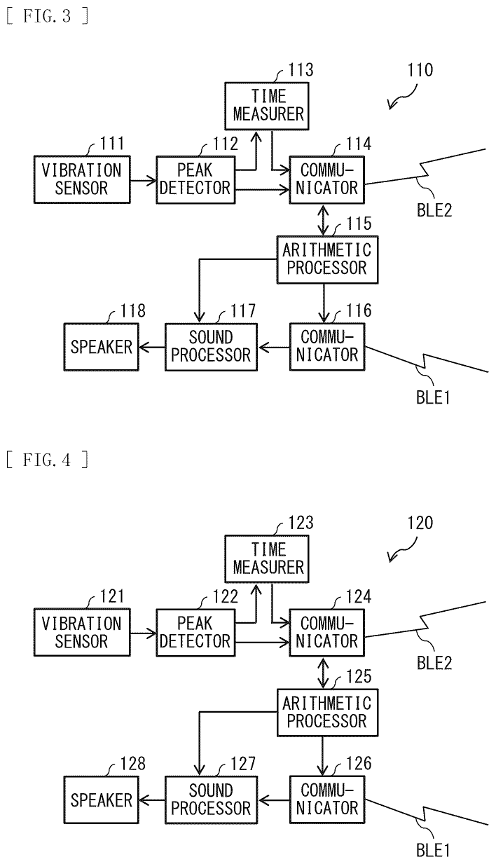

The left-side earphone 110 is attached to a left ear of a person, and includes, for example, as illustrated in FIG. 3, a vibration sensor 111, a peak detector 112, a time measurer 113, a communicator 114, an arithmetic processor 115, a communicator 116, a sound processor 117, and a speaker 118. The vibration sensor 111 corresponds to one specific example of a “detector configured to detect a signal input that comes from outside” and a “first detector configured to detect a signal input that comes from outside” according to the present disclosure. The communicator 114 corresponds to one specific example of a “first communicator” according to the present disclosure.

The vibration sensor 111 is configured to detect vibrations of the left-side earphone 110, and output a vibration signal acquired through the detection to the peak detector 112. The vibration sensor 111 includes, for example, a gyro sensor configured to detect an angular velocity of the left-side earphone 110. The vibration sensor 111 is, for example, configured to generate a vibration signal on the basis of a signal of the angular velocity detected by the gyro sensor.

The peak detector 112 is configured to detect a peak included in the vibration signal inputted from the vibration sensor 111. The peak detector 112 is configured to output a peak signal acquired through the peak detection to the time measurer 113 and the communicator 114. The peak detector 112 is further configured to output peak information acquired through the peak detection to the communicator 114. The peak information includes at least a magnitude of the peak (a vibration amplitude value).

The peak detector 112 includes, for example, a comparator. The comparator is configured to generate a digital signal of “1” when a value of a vibration signal exceeds a predetermined threshold value, and generate a digital signal of “0” when a value of a vibration signal is equal to or less than the predetermined threshold value. The peak detector 112 is, for example, configured to output the digital signal of “1” generated by the comparator as a peak signal. The peak detector 112 is, for example, further configured to detect a maximum value of the vibration signal within a predetermined period of time from when the peak signal is outputted from the comparator, and output the detected maximum value as a vibration amplitude value.

The time measurer 113 is configured to use an input of the peak signal from the peak detector 112 as a trigger to start time measurement. The time measurer 113 is configured to output a measurement start time to the communicator 114. The time measurer 113 is further configured to output a change end signal to the communicator 114 in a case where there is no input of a new peak signal until a predetermined period of time has passed from the start of the measurement. The change end signal is a signal indicating that a changed value of a Connection Interval is to be returned to an original value. The “predetermined period of time” for outputting the change end signal is set in advance by a user, for example. The time measurer 113 includes, for example, a timer configured to output pulses at predetermined cycles and a counter configured to count the pulses outputted from the timer. The time measurer 113 is, for example, configured to use an input of the peak signal as a trigger, cause the counter to count the pulses outputted from the timer, and output the change end signal when a value of the count exceeds a predetermined threshold value corresponding to the “predetermined period of time”.

The communicator 114 is configured to perform communication with the right-side earphone 120 (specifically, a communicator 124 described later) via the communication network BLE2. The communicator 114 is configured to use an input of the peak signal from the peak detector 112 as a trigger to execute the processing for changing the Connection Interval for BLE. That is, the communicator 114 is configured to serve as a master in BLE communication with the right-side earphone 120 via the communication network BLE2. The communicator 114 includes, for example, a communication interface circuit conforming to BLE, which is configured to execute the processing. The processing in the communication interface circuit will be described later in detail.

The communicator 114 is further configured to output first vibration detection information inputted from the peak detector 112 and the time measurer 113 and second vibration detection information inputted from the right-side earphone 120 to the arithmetic processor 115. The first vibration detection information includes the peak information (the vibration amplitude value) inputted from the peak detector 112 and the measurement start time inputted from the time measurer 113. The second vibration detection information includes peak information (a vibration amplitude value) acquired by a peak detector 122 described later and a measurement start time acquired by a time measurer 123 described later.

The arithmetic processor 115 is configured to execute command generation processing on the basis of the first and second vibration detection information inputted from the communicator 114. The arithmetic processor 115 is, for example, configured to determine whether or not there is a command that has been erroneously detected on the basis of the first and second vibration detection information inputted from the communicator 114, and execute the command generation processing in accordance with a result of the determination. A method for the determination and the command generation processing will be described later in detail. The arithmetic processor 115 may be configured to output predetermined sound data to the sound processor 117 for the command generation processing. The arithmetic processor 115 may be, for example, configured to output electronic sound data indicating reception of a command and a type of the received command to the sound processor 117. The arithmetic processor 115 is further configured to output, in a case where a command for providing a request to the terminal device 200 is included as a result of the command generation processing, data including the command, for example, to the communicator 116.

The communicator 116 is configured to perform communication with the terminal device 200 (the communicator 205) via the communication network BLE1. The communicator 116 is, for example, configured to receive music data from the terminal device 200 (the communicator 205) via the communication network BLE1. The communicator 116 is, for example, configured to output the music data received from the terminal device 200 (the communicator 205) to the sound processor 117. The communicator 116 is configured to transmit the data including the command, for example, which is received from the arithmetic processor 115, to the terminal device 200 (the communicator 205) via the communication network BLE1.

The sound processor 117 is, for example, configured to convert the electronic sound data inputted from the arithmetic processor 115 and the music data inputted from the communicator 116 into drive signals, and output the converted drive signals to the speaker 118. The speaker 118 is configured to output sound on the basis of the drive signals inputted from the sound processor 117.

### (Right-Side Earphone 120)

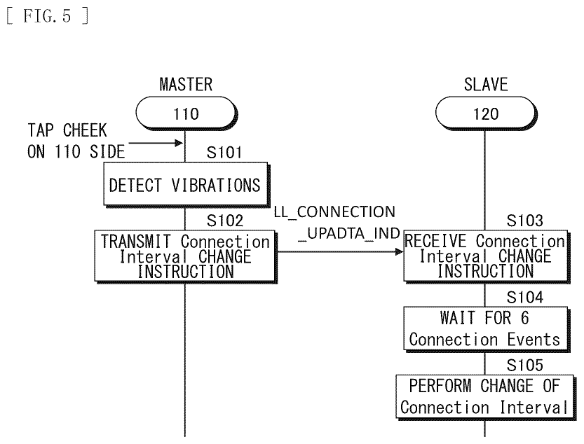

The right-side earphone 120 is attached to a right ear of the person, and includes, for example, as illustrated in FIG. 4, a vibration sensor 121, the peak detector 122, the time measurer 123, the communicator 124, an arithmetic processor 125, a communicator 126, a sound processor 127, and a speaker 128. The vibration sensor 121 corresponds to one specific example of a “second detector configured to detect a signal input that comes from outside” according to the present disclosure. The communicator 124 corresponds to one specific example of a “second communicator” according to the present disclosure.

The vibration sensor 121 is configured to detect vibrations of the right-side earphone 120, and output a vibration signal acquired through the detection to the peak detector 122. The vibration sensor 121 includes, for example, a gyro sensor configured to detect an angular velocity of the right-side earphone 120. The vibration sensor 121 is, for example, configured to generate a vibration signal on the basis of a signal of the angular velocity detected by the gyro sensor.

The peak detector 122 is configured to detect a peak included in the vibration signal inputted from the vibration sensor 121. The peak detector 122 is configured to output a peak signal acquired through the peak detection to the time measurer 123. The peak detector 122 is further configured to output peak information acquired through the peak detection to the communicator 124. The peak information includes at least a magnitude of the peak (a vibration amplitude value).

The peak detector 122 includes, for example, a comparator. The comparator is configured to generate a digital signal of “1” when a value of a vibration signal exceeds a predetermined threshold value, and generate a digital signal of “0” when a value of a vibration signal is equal to or less than the predetermined threshold value. The peak detector 122 is, for example, configured to output the digital signal of “1” generated by the comparator as a peak signal. The peak detector 122 is, for example, further configured to detect a maximum value of the vibration signal within a predetermined period of time from when the peak signal is outputted from the comparator, and output the detected maximum value as a vibration amplitude value.

The time measurer 123 is configured to use an input of the peak signal from the peak detector 122 as a trigger to start time measurement. The time measurer 123 is configured to output a measurement start time to the communicator 124. The time measurer 123 is further configured to output a change end signal to the communicator 114 in a case where there is no input of a new peak signal until a predetermined period of time has passed from the start of the measurement. The “predetermined period of time” for outputting the change end signal is set in advance by the user, for example. The time measurer 123 includes, for example, a timer configured to output pulses at predetermined cycles and a counter configured to count the pulses outputted from the timer. The time measurer 123 is, for example, configured to use an input of the peak signal as a trigger, cause the counter to count the pulses outputted from the timer, and output the change end signal when a value of the count exceeds a predetermined threshold value corresponding to the “predetermined period of time”.

The communicator 124 is configured to perform communication with the left-side earphone 110 (the communicator 114) via the communication network BLE2. The communicator 124 is configured to execute the processing for changing the Connection Interval for BLE when a Connection Interval change instruction for BLE is received from the left-side earphone 110 via the communication network BLE2. That is, communicator 124 is configured to serve as a slave in BLE communication with the left-side earphone 110 via the communication network BLE2. The communicator 114 includes, for example, a communication interface circuit conforming to BLE, which is configured to execute the processing. The processing in the communication interface circuit will be described later in detail.

The communicator 124 is further configured to transmit the second vibration detection information inputted from the peak detector 122 and the time measurer 123 to the left-side earphone 110 via the communication network BLE2 in response to a request provided from the left-side earphone 110. The second vibration detection information includes, as described above, the peak information (the vibration amplitude value) acquired by the peak detector 122 and the measurement start time acquired by the time measurer 123.

The arithmetic processor 125 is, for example, configured to output predetermined data to the communicator 126 and the sound processor 127, as necessary.

The communicator 126 is configured to perform communication with the terminal device 200 (the communicator 205) via the communication network BLE1. The communicator 126 is, for example, configured to receive music data from the terminal device 200 (the communicator 205) via the communication network BLE1. The communicator 126 is, for example, configured to output the music data received from the terminal device 200 (the communicator 205) to the sound processor 127. The communicator 126 is, for example, configured to transmit the data received from the arithmetic processor 115 to the terminal device 200 (the communicator 205) via the communication network BLE1, as necessary.

The sound processor 127 is, for example, configured to convert the data inputted from the arithmetic processor 125 and the music data inputted from the communicator 126 into drive signals, and output the converted drive signals to the speaker 128. The speaker 128 is configured to output sound on the basis of the drive signals inputted from the sound processor 127.

### [Operation]

Next, operation in the communication system 1 will now be described herein.

FIG. 5 illustrates an example of a communication procedure for the left-side earphone 110 (the master) and the right-side earphone 120 (the slave) in the communication system 1. Note that it is assumed that a data channel serves as a communication face.

It is first assumed that the user has tapped his or her left cheek (the cheek on the left-side earphone 110 side). Vibrations on the cheek, which have occurred due to the tapping, are then transmitted to the left-side earphone 110, and the vibration sensor 111 detects the vibrations, and outputs a vibration signal to the peak detector 112 (step S101). The peak detector 112 detects a peak included in the vibration signal inputted from the vibration sensor 111, and outputs a peak signal to the communicator 114. The left-side earphone 110 (the communicator 114) uses an input of the peak signal from the peak detector 112 as a trigger, and changes the Connection Interval for BLE. Then, the left-side earphone 110 (the communicator 114) uses an input of the peak signal from the peak detector 112 as a trigger to transmit a change instruction for the Connection Interval for BLE to, and the left-side earphone 110 (the communicator 114) uses an input of the peak signal from the peak detector 112 as a trigger to transmit a change instruction for the Connection Interval for BLE to the right-side earphone 120 (the communicator 124) via the communication network BLE2 (step S102).

At this time, the change instruction is, for example, LL_CONNECTION_UPDATE_IND (a command for Link Layer). The command includes at least a value of the Connection Interval (a value within a range between 7.5 ms to 4 sec).

The right-side earphone 120 (the communicator 124) receives the change instruction for the Connection Interval for BLE from the left-side earphone 110 via the communication network BLE2 (step S103). Then, the communicator 124 changes, after waiting for a period of time determined in the BLE standard (6 Connection Events), the value of the Connection Interval for BLE to the value included in the change instruction (steps S104, S105).

After the series of processing has been completed, BLE communication is performed between the left-side earphone 110 (the communicator 114) and the right-side earphone 120 (the communicator 124) at the Connection Interval after changed.

In the communication procedure described above, the master has taken an initiative to perform communication. However, it is possible to use a request provided from the slave as a trigger to perform communication, as described below.

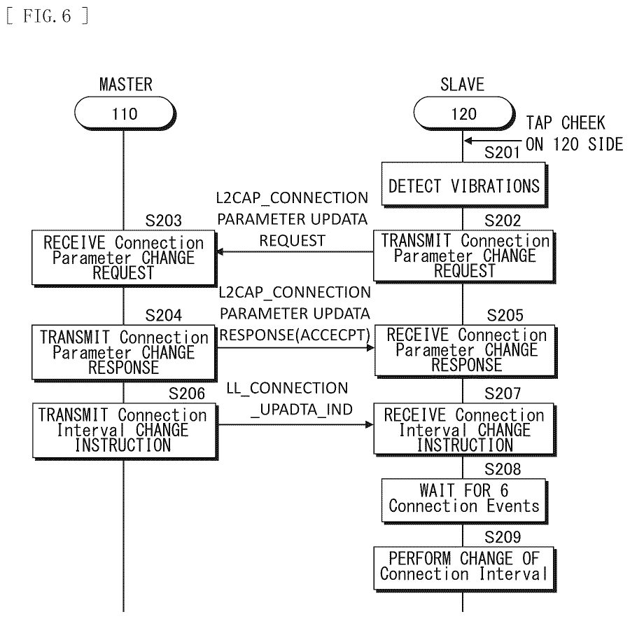

FIG. 6 illustrates an example of a communication procedure for the left-side earphone 110 (the master) and the right-side earphone 120 (the slave) in the communication system 1. Note that it is assumed that a data channel serves as a communication face.

It is first assumed that the user has tapped his or her right cheek (the cheek on the right-side earphone 120 side). Vibrations on the cheek, which have occurred due to the tapping, are then transmitted to the right-side earphone 120, and the vibration sensor 121 detects the vibrations, and outputs a vibration signal to the peak detector 122 (step S201). The peak detector 122 detects a peak included in the vibration signal inputted from the vibration sensor 121, and outputs a peak signal to the communicator 124. The right-side earphone 120 (the communicator 124) uses an input of the peak signal from the peak detector 122 as a trigger to transmit a Connection Parameter change request for BLE to the left-side earphone 110 (the communicator 114) via the communication network BLE2 (step S202). At this time, the change request is, for example, L2CAP_CONNECTION PARAMETER UPDATE REQUEST.

The left-side earphone 110 (the communicator 114) receives the Connection Parameter change request for BLE from the right-side earphone 120 via the communication network BLE2 (step S203). Then, the left-side earphone 110 (the communicator 114) transmits a ConnectionParameter change response for BLE to the right-side earphone 120 (the communicator 124) via the communication network BLE2 (step S204). At this time, the change response is, for example, L2CAP_CONNECTION PARAMETER UPDATE RESPONSE (ACCEPT).

The right-side earphone 120 (the communicator 124) receives the ConnectionParameter change response for BLE from the left-side earphone 110 (the communicator 114) via the communication network BLE2 (step S205). Thus, an environment for transmitting a Connection Interval change instruction for BLE is prepared.

After that, the left-side earphone 110 (the communicator 114) changes the Connection Interval for BLE. The left-side earphone 110 (the communicator 114) further transmits a change instruction for the Connection Interval for BLE to the right-side earphone 120 (the communicator 124) via the communication network BLE2 (step S206).

At this time, the change instruction is, for example, LL_CONNECTION_UPDATE_IND (a command for Link Layer). The command includes at least a value of the Connection Interval (a value within a range between 7.5 ms to 4 sec).

The right-side earphone 120 (the communicator 124) receives the change instruction for the Connection Interval for BLE from the left-side earphone 110 via the communication network BLE2 (step S207). Then, the communicator 124 changes, after waiting for a period of time determined in the BLE standard (6 Connection Events), the value of the Connection Interval for BLE to the value included in the change instruction (steps S208, S209).

After the series of processing has been completed, BLE communication is performed between the left-side earphone 110 (the communicator 114) and the right-side earphone 120 (the communicator 124) at the Connection Interval after changed.

Next, an example of BLE communication at the Connection Interval after changed will now be described herein. In a case where the value of the Connection Interval has been changed to a smaller value after having undergone the procedure described above, it is possible to execute processing where higher responsiveness is demanded. Examples of the processing where higher responsiveness is demanded include a determination of whether or not there is a command that has been erroneously detected and the command generation processing in accordance with a result of the determination, which are described above.

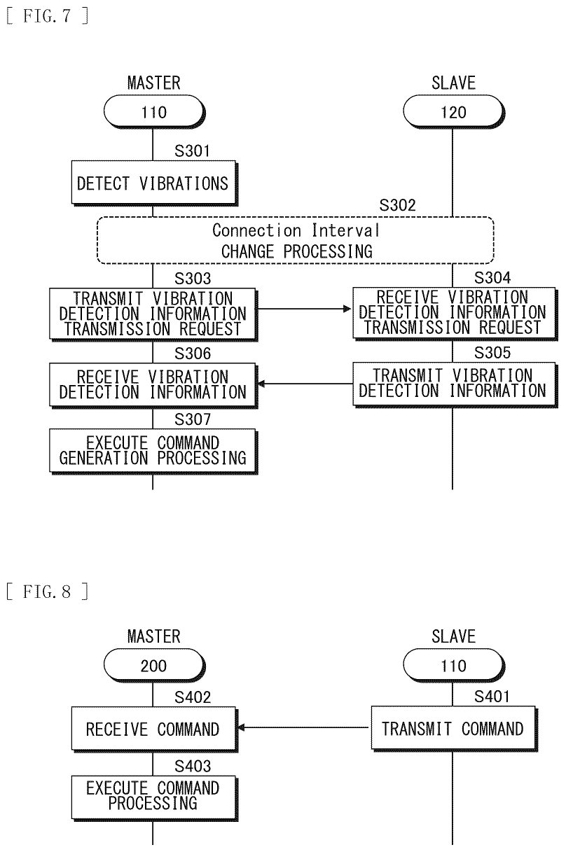

FIG. 7 illustrates an example of a communication procedure for the left-side earphone 110 and the right-side earphone 120 in the communication system 1. Note that it is assumed that a data channel serves as a communication face.

It is first assumed that the user has tapped his or her left cheek (the cheek on the left-side earphone 110 side). Vibrations on the cheek, which have occurred due to the tapping, are then transmitted to the left-side earphone 110, and the vibration sensor 111 detects the vibrations, and outputs a vibration signal to the peak detector 112 (step S301). Next, the left-side earphone 110 and the right-side earphone 120 execute steps S102 to S105 in the processing (Connection Interval change processing) (step S302).

Next, the left-side earphone 110 (the communicator 114) transmits a vibration detection information transmission request to the right-side earphone 120 (the communicator 124) via the communication network BLE2 (step S303). As the vibration detection information transmission request is received from the left-side earphone 110 (the communicator 114) via the communication network BLE2 (step S304), the right-side earphone 120 (the communicator 124) transmits second vibration detection information to the left-side earphone 110 (the communicator 114) via the communication network BLE2 (step S305). The left-side earphone 110 (the communicator 114) receives the second vibration detection information as a response to the vibration detection information transmission request from the left-side earphone 110 (the communicator 114) via the communication network BLE2 (step S306). Then, the arithmetic processor 115 determines whether or not there is a command that has been erroneously detected on the basis of the received second vibration detection information and the first vibration detection information, and executes the command generation processing in accordance with a result of the determination (step S307).

The arithmetic processor 115, for example, compares the measurement start time acquired by the time measurer 113 and the measurement start time acquired by the time measurer 123 with each other, and determines which one of the measurement start times corresponds to an earlier time. The arithmetic processor 115, for example, further compares the peak information (the vibration amplitude value) acquired by the peak detector 112 and the peak information (the vibration amplitude value) acquired by the peak detector 122 with each other, and determines which one of the pieces of peak information (the vibration amplitude values) has a greater value. It is assumed, as a result, that the measurement start time acquired by the time measurer 113 be earlier than the measurement start time acquired by the time measurer 123, and the peak information (the vibration amplitude value) acquired by the peak detector 112 be greater than the peak information (the vibration amplitude value) acquired by the peak detector 122. In this case, the arithmetic processor 115, for example, determines that the first vibration detection information is true, and the second vibration detection information is regarded as information that the user does not desire, and utilizes the first vibration detection information in later steps of the command generation processing.

FIG. 8 illustrates an example of a communication procedure for the left-side earphone 110 and the terminal device 200 in the communication system 1. Note that it is assumed that a data channel serves as a communication face. Note that the terminal device 200 serves as a master in BLE communication with the left-side earphone 110 via the communication network BLE1. The left-side earphone 110 serves as a slave in BLE communication with the terminal device 200 via the communication network BLE1.

The left-side earphone 110 and the terminal device 200 prepare an environment for transmitting a command on the basis of a request provided from the slave side. After that, the left-side earphone 110 transmits the command generated through the command generation processing described above to the terminal device 200 via the communication network BLE1 (step S401). The terminal device 200 receives the command from the left-side earphone 110 via the communication network BLE1 (step S402), and executes the received command (step S403).

Note that, in a case where the time measurer 113 has outputted a change end signal to the communicator 114, the left-side earphone 110 (the communicator 114) uses an input of the change end signal as a trigger to change the value of the Connection Interval for BLE to the value of the Connection Interval before the change. The left-side earphone 110 (the communicator 114) further uses the input of the change end signal as a trigger to transmit a change instruction for the Connection Interval for BLE to the right-side earphone 120 (the communicator 124) via the communication network BLE2. At this time, the change instruction includes the value of the Connection Interval before the change.

The right-side earphone 120 (the communicator 124) receives the change instruction for the Connection Interval for BLE from the left-side earphone 110 via the communication network BLE2. Then, the communicator 124 changes, after waiting for a period of time determined in the BLE standard (6 Connection Events), the value of the Connection Interval for BLE to the value included in the change instruction.

After the series of processing has been completed, BLE communication is performed between the left-side earphone 110 (the communicator 114) and the right-side earphone 120 (the communicator 124) at the Connection Interval before the change.

### [Effects]

Next, effects of the communication system 1 will now be described herein.

In the present embodiment, a fact that there is a detection of vibrations on at least either one of the left-side earphone 110 and the right-side earphone 120 (a peak detection) is used as a trigger to change the Connection Interval for BLE. Thus, it is possible to perform communication between the left-side earphone 110 and the right-side earphone 120 on the basis of a detection of vibrations at higher responsiveness. Therefore, it is possible to acquire responsiveness in accordance with an application.

In the present embodiment, a value of the Connection Interval, which is changed by the left-side earphone 110 (the communicator 114), is transmitted to the right-side earphone 120 (the communicator 124) via the communication network BLE2. Thus, it is possible to perform communication between the left-side earphone 110 and the right-side earphone 120 on the basis of a detection of vibrations at higher responsiveness. Therefore, it is possible to acquire responsiveness in accordance with an application.

In the present embodiment, in a case where there is no detection of vibrations on at least either one of the left-side earphone 110 and the right-side earphone 120 (a peak detection) for a predetermined period of time, the value of the Connection Interval is returned to the value before the change. Thus, it is possible to suppress excessive consumption of electric power.

### 3. Second Embodiment

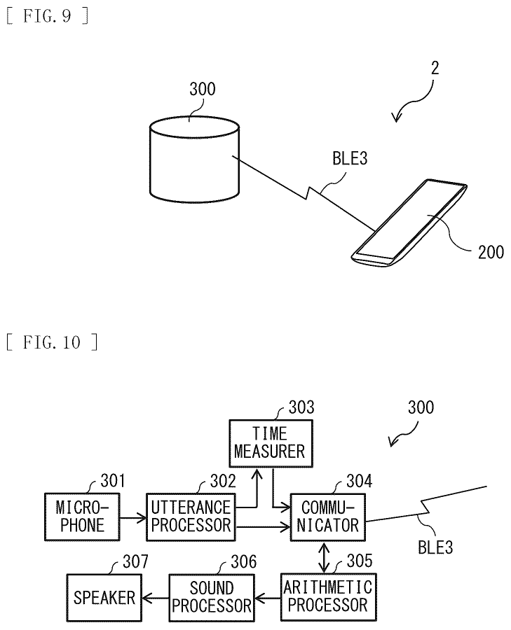

Next, a communication system 2 according to a second embodiment of the present disclosure will now be described herein. FIG. 9 illustrates an outline configuration example of the communication system 2. The communication system 2 includes, for example, as illustrated in FIG. 9, a smart speaker 300 and the terminal device 200. The smart speaker 300 corresponds to one specific example of a “master device” according to the present disclosure. The terminal device 200 corresponds to one specific example of a “slave device” according to the present disclosure. The smart speaker 300 and the terminal device 200 are communicable to each other by using a BLE standard. In FIG. 9, a communication network based on BLE, which is formed between the smart speaker 300 and the terminal device 200, is expressed as BLE3.

The terminal device 200 is configured to transmit data including music data, for example, with respect to the smart speaker 300 via the communication network BLE3. The smart speaker 300 is a device to which it is possible to input sound, and includes, for example, as illustrated in FIG. 10, a microphone 301, an utterance processor 302, a time measurer 303, a communicator 304, an arithmetic processor 305, a sound processor 306, and a speaker 307. The microphone 301 corresponds to one specific example of a “detector configured to detect a signal input that comes from outside” according to the present disclosure.

The microphone 301 is a device configured to detect ambient sound (for example, an utterance that has occurred outside), and is configured to output a sound signal acquired through the detection to the utterance processor 302.

The utterance processor 302 is configured to analyze the sound signal inputted from the microphone 301, and determine whether or not the sound signal includes a signal component corresponding to a predetermined sound command. Examples of the “predetermined sound command” include a start command that means starting of the smart speaker 300 and a function command for executing a predetermined function of the terminal device 200. Examples of the function command include a music playing command that instructs playing of designated music data.

The utterance processor 302 is configured to output, in a case where the sound signal includes a signal component corresponding to the start command, as a result of the determination, a start signal meaning that the start command has been inputted to the time measurer 303 and the communicator 304. The utterance processor 302 is further configured to output the start command to the communicator 304. The utterance processor 302 is configured to output, in a case where the sound signal includes a signal component corresponding to a function command, as a result of the determination, a function signal meaning that the function command has been inputted to the time measurer 303 and the communicator 304. The utterance processor 302 is further configured to output the function command to the communicator 304.

The time measurer 303 is configured to use an input of the start signal from the utterance processor 302 as a trigger to start time measurement. The time measurer 303 is configured to output a change end signal to the communicator 304 in a case where there is no input of a new signal (for example, the function signal) until a predetermined period of time has passed from the start of the measurement. The change end signal is a signal indicating that a changed value of a Connection Interval is to be returned to an original value. The “predetermined period of time” for outputting the change end signal is set in advance by the user, for example. The time measurer 303 includes, for example, a timer configured to output pulses at predetermined cycles and a counter configured to count the pulses outputted from the timer. The time measurer 303 is, for example, configured to use an input of the start signal as a trigger, cause the counter to count the pulses outputted from the timer, and output the change end signal when a value of the count exceeds a predetermined threshold value corresponding to the “predetermined period of time”.

The communicator 304 is configured to perform communication with the terminal device 200 (the communicator 205) via the communication network BLE3. The communicator 304 is configured to use an input of the start signal from the utterance processor 302 as a trigger to execute the processing for changing the Connection Interval for BLE. That is, the communicator 304 is configured to serve as a master in BLE communication with the terminal device 200 via the communication network BLE3. The communicator 304 includes, for example, a communication interface circuit conforming to BLE, which is configured to execute the processing. The processing in the communication interface circuit will be described later in detail.

The communicator 304 is configured to transmit, when the function command is inputted from the utterance processor 302, the inputted function command to the terminal device 200 (the communicator 205) via the communication network BLE3. The communicator 304 is configured to receive, in a case where the function command transmitted to the terminal device 200 (the communicator 205) is the music playing command, for example, music streaming data from the terminal device 200 (the communicator 205). The communicator 304 is configured to at this time output the received music streaming data to the arithmetic processor 305.

The arithmetic processor 305 is, for example, configured to output predetermined data to the communicator 304 and the sound processor 306, as necessary. The arithmetic processor 305 is, for example, configured to output the music streaming data received from the communicator 304 to the sound processor 306.

The sound processor 306 is, for example, configured to convert the data inputted from the arithmetic processor 305 into drive signals, and output the converted drive signals to the speaker 307. The speaker 307 is configured to output sound on the basis of the drive signals inputted from the sound processor 306.

### [Operation]

Next, operation in the communication system 2 will now be described herein.

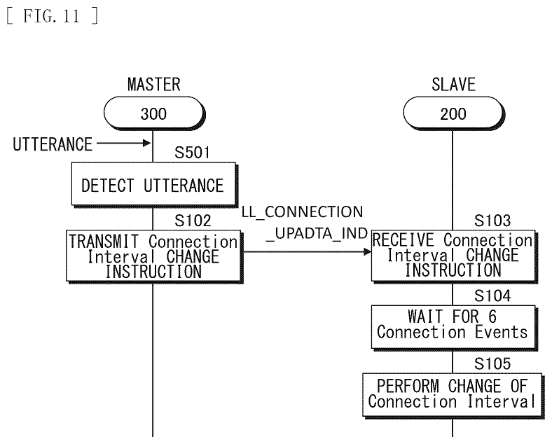

FIG. 11 illustrates an example of a communication procedure for the smart speaker 300 (the master) and the terminal device 200 (the slave) in the communication system 2. Note that it is assumed that a data channel serves as a communication face.

It is first assumed that the user has uttered the start command toward the smart speaker 300. Then, the microphone 301 detects the utterance of the user, and the utterance processor 302 detects the start command from a sound signal (step S501). At this time, the utterance processor 302 outputs the start signal to the time measurer 303 and the communicator 304. The utterance processor 302 further outputs the start command to the communicator 304.

The communicator 304 uses an input of the start signal from the utterance processor 302 as a trigger to change the Connection Interval for BLE. Furthermore, the communicator 304 uses the input of the start signal from the utterance processor 302 as a trigger to transmit a change instruction for the Connection Interval for BLE to the terminal device 200 (the communicator 205) via the communication network BLE3 (step S502). At this time, the change instruction is, for example, LL_CONNECTION_UPDATE_IND (a command for Link Layer). The command includes at least a value of the Connection Interval (a value within a range between 7.5 ms to 4 sec).

The terminal device 200 (the communicator 205) receives the change instruction for the Connection Interval for BLE from the smart speaker 300 via the communication network BLE3 (step S503). Then, the communicator 205 changes, after waiting for a period of time determined in the BLE standard (6 Connection Events), the value of the Connection Interval for BLE to the value included in the change instruction (steps S504, S505).

After the series of processing has been completed, BLE communication is performed between the smart speaker 300 (the communicator 304) and the terminal device 200 (the communicator 205) at the Connection Interval after changed.

It is assumed that, after the value of the Connection Interval has been changed, the user has uttered the music playing command toward the smart speaker 300. Then, the microphone 301 detects the utterance of the user, and the utterance processor 302 detects the music playing command from a sound signal. At this time, the utterance processor 302 outputs the music playing command to the communicator 304.

The communicator 304 transmits, as the music playing command is inputted from the utterance processor 302, the inputted music playing command to the terminal device 200 at the Connection Interval after changed. The terminal device 200 generates, as the music playing command is inputted from the smart speaker 300 (the communicator 304), music streaming data corresponding to the inputted music playing command. The terminal device 200 transmits the generated music streaming data to the smart speaker 300 (the communicator 304) at the Connection Interval after changed.

The smart speaker 300 (the communicator 304) outputs, as the music streaming data is received from the terminal device 200 via the communication network BLE3, the received music streaming data to the sound processor 306 via the arithmetic processor 305. The sound processor 306 converts the inputted music streaming data into drive signals, and outputs the converted drive signals to the speaker 307. The speaker 307 outputs sound on the basis of the drive signals inputted from the sound processor 306.

Note that, in a case where the time measurer 303 has outputted the change end signal to the communicator 304, the smart speaker 300 (the communicator 304) uses an input of the change end signal as a trigger to change the value of the Connection Interval for BLE to the value of the Connection Interval before the change. Furthermore, the smart speaker 300 (the communicator 304) uses the input of the change end signal as a trigger to transmit a change instruction for the Connection Interval for BLE to the terminal device 200 (the communicator 205) via the communication network BLE3. At this time, the change instruction includes the value of the Connection Interval before the change.

The terminal device 200 (the communicator 205) receives the change instruction for the Connection Interval for BLE from the smart speaker 300 via the communication network BLE2. Then, the communicator 205 changes, after waiting for a period of time determined in the BLE standard (6 Connection Events), the value of the Connection Interval for BLE to the value included in the change instruction.

After the series of processing has been completed, BLE communication is performed between the smart speaker 300 (the communicator 304) and the terminal device 200 (the communicator 205) at the Connection Interval before the change.

### [Effects]

Next, effects of the communication system 2 will now be described herein.

In the present embodiment, a fact that there is a detection of an utterance in the smart speaker 300 is used as a trigger to change the Connection Interval for BLE. Thus, it is possible to perform communication between the smart speaker 300 and the terminal device 200 on the basis of a detection of an utterance at higher responsiveness. Therefore, it is possible to acquire responsiveness in accordance with an application.

In the present embodiment, a value of the Connection Interval, which is changed by the smart speaker 300 (the communicator 304), is transmitted to the terminal device 200 (the communicator 205) via the communication network BLE3. Thus, it is possible to perform communication between the smart speaker 300 and the terminal device 200 on the basis of a detection of an utterance at higher responsiveness. Therefore, it is possible to acquire responsiveness in accordance with an application.

In the present embodiment, in a case where there is no detection of an utterance in the smart speaker 300 for a predetermined period of time, the value of the Connection Interval is returned to the value before the change. Thus, it is possible to suppress excessive consumption of electric power.

Although the present disclosure has been described with reference to the embodiments, modification examples, and application examples, the present disclosure is not limited to the above-described embodiments and the like, and various modifications are possible. It should be noted that the effects described in this specification are only exemplified. Effects of the present disclosure are not limited to the effects described herein. The present disclosure may have effects other than the effects described herein.

For example, the present disclosure may also be configured as follows.
(1)

A communication device including:
a detector configured to detect a signal input that comes from outside; and
a changer configured to use a fact that there is a detection in the detector as a trigger to change a Connection Interval for Bluetooth (registered trademark) Low Energy (BLE).
(2)

The communication device according to (1), in which the detector is a sensor configured to detect a vibration applied from the outside.
(3)

The communication device according to (1), in which the detector is a sensor configured to detect an utterance that has occurred at the outside.
(4)

The communication device according to any one of (1) to (3), further including a transmitter configured to transmit a value of the Connection Interval, the value being changed by the changer, to an external device by using a BLE communication.
(5)

The communication device according to any one of (1) to (4), in which the changer is configured to return a value of the Connection Interval to a value that is before the change is made, in a case where there is no detection of the signal input in the detector for a predetermined period of time.
(6)

A communication system that includes a master device and a slave device communicable to each other by using a Bluetooth (registered trademark) Low Energy (BLE) communication, the master device including:
a first detector configured to detect a signal input that comes from outside; and
   a first communicator configured to use a fact that there is a detection in the first detector as a trigger to transmit, to the slave device by using the BLE communication, a change instruction for a value of a Connection Interval for BLE.
(7)

The communication system according to (6), in which
the first communicator is configured to transmit a vibration detection information transmission request to the slave device by using the BLE communication, and receive vibration detection information as a response to the vibration detection information transmission request from the slave device by using the BLE communication, and
the master device further includes a determiner configured to perform a determination that there is an erroneous detection on a basis of a result of the detection in the first detector and the vibration detection information received from the slave device.
(8)

The communication system according to (7), in which the slave device includes:
a second detector configured to detect a signal input that comes from the outside; and
a second communicator configured to use a fact that there is a detection in the second detector as a trigger to transmit, to the master device by using the BLE communication, a change request for the value of the Connection Interval for the BLE.
(9)

The communication system according to (8), in which the second communicator is configured to receive a vibration detection information transmission request from the slave device by using the BLE communication, and transmit a result of the detection in the second detector as a response to the vibration detection information transmission request to the master device by using the BLE communication.

The present application claims the benefit of Japanese Priority Patent Application JP2022-077783 filed with the Japan Patent Office on May 10, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A communication device comprising:
a detector configured to detect a signal input that comes from outside; and
a changer configured to use a fact that there is a detection in the detector as a trigger to change a Connection Interval for Bluetooth (registered trademark) Low Energy.

2. The communication device according to claim 1, wherein the detector comprises a sensor configured to detect a vibration applied from the outside.

3. The communication device according to claim 1, wherein the detector comprises a sensor configured to detect an utterance that has occurred at the outside.

4. The communication device according to claim 1, further comprising a transmitter configured to transmit a value of the Connection Interval, the value being changed by the changer, to an external device by using a BLE communication.

5. The communication device according to claim 1, wherein the changer is configured to return a value of the Connection Interval to a value that is before the change is made, in a case where there is no detection of the signal input in the detector for a predetermined period of time.

6. A communication system that includes a master device and a slave device communicable to each other by using a Bluetooth (registered trademark) Low Energy communication,
the master device comprising:
a first detector configured to detect a signal input that comes from outside; and
a first communicator configured to use a fact that there is a detection in the first detector as a trigger to transmit, to the slave device by using the BLE communication, a change instruction for a value of a Connection Interval for BLE.

7. The communication system according to claim 6, wherein
the first communicator is configured to transmit a vibration detection information transmission request to the slave device by using the BLE communication, and receive vibration detection information as a response to the vibration detection information transmission request from the slave device by using the BLE communication, and
the master device further includes a determiner configured to perform a determination that there is an erroneous detection on a basis of a result of the detection in the first detector and the vibration detection information received from the slave device.

8. The communication system according to claim 7, wherein the slave device includes:
a second detector configured to detect a signal input that comes from the outside; and
a second communicator configured to use a fact that there is a detection in the second detector as a trigger to transmit, to the master device by using the BLE communication, a change request for the value of the Connection Interval for the BLE.

9. The communication system according to claim 8, wherein the second communicator is configured to receive a vibration detection information transmission request from the slave device by using the BLE communication, and transmit a result of the detection in the second detector as a response to the vibration detection information transmission request to the master device by using the BLE communication.
